(19) United States
(12) Patent Application Publication
(10) Pub. No.: US 2026/0119305 A1
(43) Pub. Date: Apr. 30, 2026

(54) AUTOMATED FAILURE MANAGEMENT PLATFORM

(71) Applicant: Truist Bank, Charlotte, NC (US)

(72) Inventors: Kavichezliyan Rajendran, Johns Creek, GA (US); Veeraraghavan Krishnamoorthy, Cumming, GA (US); Rajesh Teki, Buford, GA (US)

(73) Assignee: Truist Bank, Charlotte, NC (US)

(21) Appl. No.: 18/932,162

(22) Filed: Oct. 30, 2024

(51) Int. Cl. G06F 11/07; G06F 8/65; G06F 8/70

(52) U.S. Cl. CPC G06F 11/0793; G06F 8/65; G06F 8/70; G06F 11/0766; G06F 11/079

(57) ABSTRACT

Disclosed are systems and methods for automatically detecting faults in software applications or hardware components. The faults are characterized according to the effect, or underlying cause of the fault, or another criteria. The system automatically selects or generates a correction for the faults that is sent to the computing device where the fault began as part of correcting the fault. The fault can be characterized or the correction can be generated using machine learning technology.

### TECHNICAL FIELD AND BACKGROUND

The present invention relates generally to the field of fault detection and correction, and in particular, systems and methods for automatically detecting and characterizing system faults and implementing corrective measures.

Existing methods for detecting and correcting system faults are manual and reactive. It is incumbent on individual end users to observe and report system faults and take steps to investigate and repair faults that arise. The manual detection and correction of faults often leads to end user friction that negatively impacts the end user experience. For enterprises that support a significant number of end users, manual techniques for addressing fault consume substantial resources and take significant time to address resulting in prolonged system downtime and lost production for severe faults.

The present systems and methods address the drawbacks of existing systems by providing automated fault detection, characterization, and correction. The system actively monitors and recognizes software and hardware fault conditions and characterizes the faults so that an enterprise can recognize trends and develop and deploy corrections for those faults that occur most often or that have the most significant impact.

### SUMMARY

Disclosed are systems and methods for fault management that include a computer with a processor and a memory device that stores data and executable code. When the code is executed, it causes the processor to execute a series of operations that include instructing a computing device to report a fault notification. The fault notification is generated in response to the occurrence of a fault by a software application running on the computing device. The fault notification includes fault reporting data relating to the fault. The fault reporting data can be a broad range of data types that relate to the fault, including, without limitation, a description of the fault, log files, or screens captures that show how to reproduce or fix the fault.

The system characterizes the fault using the fault reporting data. The system then generates a correction for the fault based on the fault characterization and the fault reporting data. The correction includes executable correction instructions. The correction is deployed to the computing device for execution to fix the fault.

In one embodiment, the system includes a correction database that stores known corrections that are each associated with at least one known label. The known label relates to, or describes, the correction or the fault being corrected. The system applies a label to the fault based on the characterization, such as a “login error” or a “memory error,” among almost any potential error with the software application. A correction is generated by selecting a known correction that has a known label corresponding to the label applied to the fault. The known correction is one that has previously been shown to fix the fault either through testing or deployment on a production system.

In another embodiment, the correction is selected based on the expected operation of a software application if it were not for the fault. That is, the correction is known to cause the software application to operate normally as end users expect. The system includes a correction database that stores known corrections that are each associated with at least one known operation (that is, the “normal” operation of the software application). The fault is characterized according to an expected operation—i.e., how is the software application expected to function if it were not for the error. The system generates a correction for the fault by selecting a known correction from the correction database that has a known operation that matches the expected operation. In short, the system selects a correction that is known to cause the software to operate as expected.

The correction can in some cases be an update to, or patch for, the software application that experienced the fault. Software updates and patches are known to correct some faults. The correction is sent to the computing device for installation.

In other embodiments, the system can generate a correction by modifying the source code that makes up the software application that exhibited the fault. The system first determines or identifies the source software code that caused the fault where the source software code is included in a program, software routine, or file. The system modifies the source software code by (i) deleting part of the source software code, (ii) replacing part of the source software code, or (iii) inserting additional code into the source software code. When replacing part of the source software code, it can be efficient to rely on other parts of the source code for the same software application that are known to be functioning normally.

In an additional embodiment, the system corrects the software application responsible for the fault by relying on a software template. The template is a portion of software code that includes variables or “blanks” to be completed that tailor the software template to correct the particular fault at issue or to adapt to the template correction to the particular computing device at issue. The system first determine the source software code that caused the fault and installs the template into the source software code.

Some embodiments of the system rely on machine learning to characterize the fault and/or develop corrections. The system can include a neural network that performs operations to characterize the fault through analysis of the fault reporting data. The neural network determines the probabilities that the fault will match a given characterization, and the characterization with the highest probability is taken as the characterization. The embodiment can also include a database of known corrections. The neural network analyzes the fault reporting data to determine the known correction that has the highest probability of repairing the fault.

One feature of the present system is the capability of recording faults across an enterprise system so that the faults can be monitored and analyzed to identify trends and prioritize efforts to correct the faults. For example, an enterprise might determine the faults that occur most often or that are characterized as the most severe in terms of the effects of the fault—i.e., faults that cause the system to fail as opposed to faults that might impact the functionality of one or only a few system operations. The most common or most severe failures are prioritized for correction.

The system records and characterizes a plurality of faults that each include fault reporting data and that are generated in response to the occurrence of a failure by a software application running on a computing device. The system characterizes the faults using the fault reporting data and identifies at least one of the faults as a priority for correction. The system generates a correction for the priority fault based on the fault characterization and the fault reporting data. The correction includes executable correction instructions, and the correction is deployed to the computing device that exhibited the fault for the computing device to execute the instructions. As before, the priority fault can be corrected by selecting from a database of known corrections that are each associated with a known label or a known operation.

In another example embodiment, the system detects a fault generated by a computing device component and captures fault reporting data. The system detects the fault by capturing monitoring data from a system monitoring service and determining whether the monitoring data violates a specified threshold by exceeding or falling below the threshold. The monitoring data can be one of a variety of monitoring metrics, such as network capacity utilization, processor utilization, or memory utilization, among others.

The system characterizes the fault using the fault reporting data to identify a component that failed and a fault type. The system generate a correction by correlating the component and the fault type to a known fault type and a known component in a correction database that stores a plurality of known corrections. The correction includes executable correction instructions and is deployed to the computing device for execution. The component that failed can be a hardware component or a software application installed on the computing device. The correction can be generated by using a neural network to determine the known correction among the plurality of known corrections that has the highest probability of repairing the fault.

### BRIEF DESCRIPTION OF THE DRAWINGS

Features, aspects, and advantages of the present invention are better understood when the following detailed description of the invention is read with reference to the accompanying figures, in which:

FIG. 1 illustrates an enterprise system and environment according to one embodiment.

FIG. 2A is a diagram of a feedforward network utilized in machine learning according to one embodiment.

FIG. 2B is a diagram of a convolution neural network according to an embodiment of the inventive system.

FIG. 2C is a diagram of a portion of the convolution neural network of FIG. 2B that illustrates assigned weights at connections or neurons.

FIG. 3 is a diagram representing an example weighted sum computation in a node in an artificial neural network.

FIG. 4 is a diagram of a Recurrent Neural Network according to at least one embodiment that is utilized in machine learning.

FIG. 5 is a schematic logic diagram of an artificial intelligence program including a front-end and a back-end algorithm.

FIG. 6 is a flow chart representing a method, according to at least one embodiment, of model development and deployment by machine learning.

### DETAILED DESCRIPTION

The present invention will now be described more fully hereinafter with reference to the accompanying drawings in which example embodiments of the invention are shown. However, the invention may be embodied in many different forms and should not be construed as limited to the representative embodiments set forth herein. The example embodiments are provided so that this disclosure will be both thorough and complete and will fully convey the scope of the invention and enable one of ordinary skill in the art to make, use, and practice the invention. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

It will be understood that relative terms are intended to encompass different orientations or sequences in addition to the orientations and sequences depicted in the drawings and described herein. Relative terminology, such as “substantially” or “about,” describe the specified devices, materials, transmissions, steps, parameters, or ranges as well as those that do not materially affect the basic and novel characteristics of the claimed inventions as whole (as would be appreciated by one of ordinary skill in the art).

The terms “coupled,” “fixed,” “attached to,” “communicatively coupled to,” “operatively coupled to,” and the like refer to both: (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

As used herein, the terms “enterprise” or “provider” generally describes a person or business that provides goods or services as well as access to proprietary systems for automatically detecting, characterizing, and correcting faults. The term “user” is used interchangeably with the terms end user, customer, consumer, and agents, and the term user represents individuals who operate computing devices that use the systems and methods disclosed in this application. The provider may render services or provide goods to the end user as part of one or more transactions or as part of an ongoing customer relationship that utilizes the technology described in this application. The provider might also employ groups of end users to maintain the system and perform actions that utilizes the technology described in this application as part of rendering goods and services to customers.

Embodiments are described with reference to flowchart illustrations or block diagrams of methods or apparatuses where each block or combinations of blocks can be implemented by computer-readable instructions (i.e., software). The term apparatus includes systems and computer program products. The referenced computer-readable software instructions may be provided to a processor of a general purpose computer, special purpose computer, or other programmable data processing apparatus to produce a particular machine. The instructions, which execute via the processor of the computer or other programmable data processing apparatus, create mechanisms for implementing the functions specified in this specification and attached figures.

The computer-readable instructions are loaded onto a computer or other programmable data processing apparatus to cause a series of operational steps to be performed on the computer or other programmable apparatus to produce a computer-implemented process such that the instructions, which execute on the computer or other programmable apparatus, provide steps for implementing the functions specified in the attached flowchart(s) or block diagram(s). Alternatively, computer software implemented steps or acts may be combined with operator or human implemented steps or acts in order to carry out an embodiment of the disclosed systems and methods.

The computer-readable software instructions may also be stored in a computer-readable memory that can direct a computer or other programmable data processing apparatus to function in a particular manner. In this manner, the instructions stored in the computer-readable memory produce an article of manufacture that includes the instructions, which implement the functions described and illustrated herein.

### System Level Description

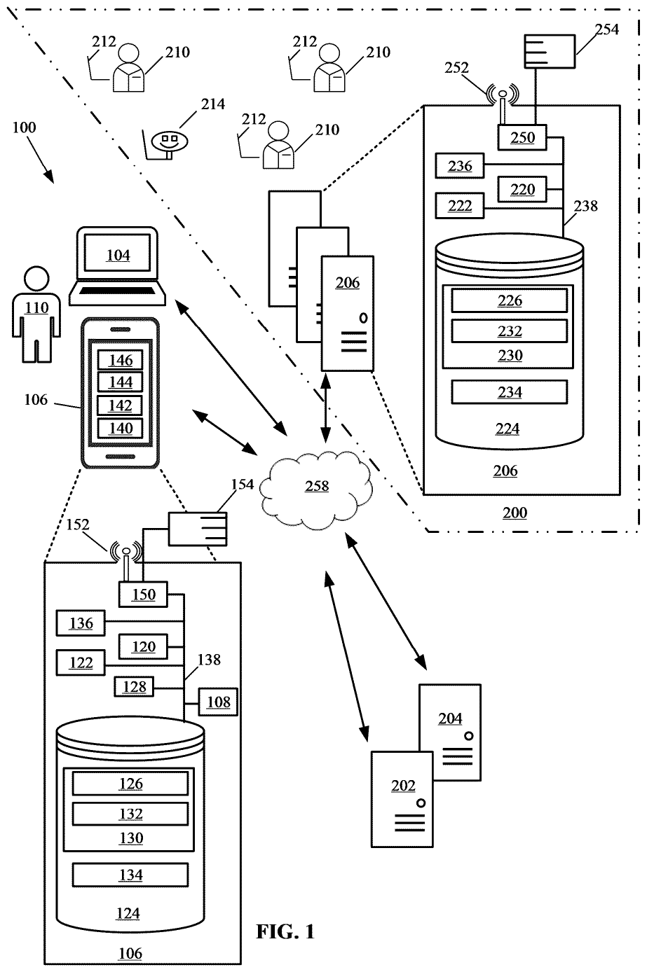

As shown in FIG. 1, a hardware system 100 configuration according to one embodiment generally includes a user 110 that benefits through use of services and products offered by a provider through an enterprise system 200. The user 110 accesses services and products by use of one or more user computing devices 104 & 106. The user computing device can be a larger device, such as a laptop or desktop computer 104, or a mobile computing device 106, such as smart phone or tablet device with processing and communication capabilities. The user computing device 104 & 106 includes integrated software applications that manage device resources, generate user interfaces, accept user inputs, and facilitate communications with other devices, among other functions. The integrated software applications can include an operating system, such as Linux®, UNIX®, Windows®, macOS®, iOS®, Android®, or other operating system compatible with personal computing devices.

The user 110 can be an individual, a group, or an entity having access to the user computing device 104 & 106. Although the user 110 is singly represented in some figures, at least in some embodiments, the user 110 is one of many, such as a market or community of users, consumers, customers, business entities, government entities, and groups of any size.

The user computing device includes subsystems and components, such as a processor 120, a memory device 122, a storage device 124, or power system 128. The memory device 122 can be transitory random access memory (“RAM”) or read-only memory (“ROM”). The storage device 124 includes at least one of a non-transitory storage medium for long-term, intermediate-term, and short-term storage of computer-readable instructions 126 for execution by the processor 120. For example, the instructions 126 can include instructions for an operating system and various integrated applications or programs 130 & 132. The storage device 124 can store various other data items 134, including, without limitation, cached data, user files, pictures, audio and/or video recordings, files downloaded or received from other devices, and other data items preferred by the user, or related to any or all of the applications or programs.

The memory device 122 and storage device 124 are operatively coupled to the processor 120 and are configures to store a plurality of integrated software applications that comprise computer-executable instructions and code executed by the processing device 120 to implement the functions of the user computing device 104 & 106 described herein. Example applications include a conventional Internet browser software application and a mobile software application created by the provider to facilitate interaction with the provider system 200.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The integrated software applications also typically provide a graphical user interface (“GUI”) on the user computing device display screen 140 that allows the user 110 to utilize and interact with the user computing device. Example GUI display screens are depicted in the attached figures. The GUI display screens may include control functions for displaying information and accepting inputs from users, such as text boxes, data fields, hyperlinks, pull down menus, check boxes, radio buttons, and the like. One of ordinary skill in the art will appreciate that the example functions and user-interface display screens shown in the attached figures are not intended to be limiting, and an integrated software application may include other display screens and functions.

The processing device 120 performs calculations, processes instructions for execution, and manipulates information. The processing device 120 executes machine-readable instructions stored in the storage device 124 and/or memory device 122 to perform methods and functions as described or implied herein. The processing device 120 can be implemented as a central processing unit (“CPU”), a microprocessor, a graphics processing unit (“GPU”), a microcontroller, an application-specific integrated circuit (“ASIC”), a programmable logic device (“PLD”), a digital signal processor (“DSP”), a field programmable gate array (“FPGA”), a state machine, a controller, gated or transistor logic, discrete physical hardware components, and combinations thereof. In some embodiments, particular portions or steps of methods and functions described herein are performed in whole or in part by way of the processing device 120. In other embodiments, the methods and functions described herein include cloud-based computing such that the processing device 120 facilitates local operations, such communication functions, data transfer, and user inputs and outputs.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The user computing device 104 & 106 may also include a positioning device 108, such as a global positioning system device (“GPS”) that determines a location of the user computing device. In other embodiments, the positioning device 108 includes a proximity sensor or transmitter, such as an RFID tag, that can sense or be sensed by devices proximal to the user computing device 104 & 106.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

A system intraconnect 138, such as a bus system, connects various components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components, either directly or indirectly—by way of intermediate component(s)—with one another.

The user computing device 104 & 106 further includes a communication interface 150. The communication interface 150 facilitates transactions with other devices and systems to provide two-way communications and data exchanges through a wireless communication device 152 or wired connection 154. Communications may be conducted via various modes or protocols, such as through a cellular network, wireless communication protocols using IEEE 802.11 standards. Communications can also include short-range protocols, such as Bluetooth or Near-field communication protocols. Communications may also or alternatively be conducted via the connector 154 for wired connections such by USB, Ethernet, and other physically connected modes of data transfer.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210 act on behalf of the provider, such as customer service representatives, advisors, managers, and sales team members.

Human agents 210 utilize agent computing devices 212 to interface with the provider system 200. The agent computing devices 212 can be, as non-limiting examples, computing devices, kiosks, terminals, smart devices such as phones, and devices and tools at customer service counters and windows at POS locations. In at least one example, the diagrammatic representation and above-description of the components of the user computing device 104 & 106 in FIG. 1 applies as well to the agent computing devices 212. As used herein, the general term “end user computing device” can be used to refer to either the agent computing device 212 or the user 110 depending on whether the agent (as an employee or affiliate of the provider) or the user (as a customer or consumer) is utilizing the disclosed systems and methods to segment, parse, filter, analyze, and display content data.

Human agents 210 interact with users 110 or other agents 212 by phone, via an instant messaging software application, or by email. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components, such as a processor device 220, an input-output system 236, an intraconnect bus system 238, a communication interface 250, a wireless device 252, a hardwire connection device 254, a transitory memory device 222, and a non-transitory storage device 224 for long-term, intermediate-term, and short-term storage of computer-readable instructions 226 for execution by the processor device 220. The instructions 226 can include instructions for an operating system and various software applications or programs 230 & 232. The storage device 224 can store various other data 234, such as cached data, files for user accounts, user profiles, account balances, and transaction histories, files downloaded or received from other devices, and other data items required or related to the applications or programs 230 & 232.

The network 258 provides wireless or wired communications among the components of the hardware system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations.

The network 258 may be or include an enterprise or secured network, or may be implemented, at least in part, through one or more connections to the Internet. A portion of the network 258 may be a virtual private network (“VPN”) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated hardware system 100.

External systems 202 and 204 represent any number and variety of data sources, users, consumers, customers, enterprises, and groups of any size. In at least one example, the external systems 202 and 204 represent remote terminal utilized by the enterprise system 200 in serving users 110. In another example, the external systems 202 and 204 represent electronic systems for processing payment transactions. The system may also utilize software applications that function using external resources 202 and 204 available through a third-party provider, such as a Software as a Service (“SasS”), Platform as a Service (“PaaS”), or Infrastructure as a Service (“IaaS”) provider running on a third-party cloud service computing device. For instance, a cloud computing device may function as a resource provider by providing remote data storage capabilities or running software applications utilized by remote devices.

SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

The embodiment shown in FIG. 1 is not intended to be limiting, and one of ordinary skill in the art will appreciate that the system and methods of the present invention may be implemented using other suitable hardware or software configurations. For example, the system may utilize only a single computing system 206 implemented by one or more physical or virtual computing devices, or a single computing device may implement one or more of the computing system 206, agent computing system 206, or user computing device 104 & 106.

### Artificial Intelligence and Neural Network Architecture

A machine learning program may be configured to implement stored processing, such as decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (“KNN”), and the like. Additionally or alternatively, the machine learning algorithm may include one or more regression algorithms configured to output a numerical value in response to a given input. Further, the machine learning may include one or more pattern recognition algorithms-e.g., a module, subroutine or the like capable of translating text or string characters and/or a speech recognition module or subroutine. The machine learning modules may include a machine learning acceleration logic (e.g., a fixed function matrix multiplication logic) that implements the stored processes or optimizes the machine learning logic training and interface.

Machine learning models are trained using various data inputs and techniques. Example training methods may include, for example, supervised learning, (e.g., decision tree learning, support vector machines, similarity and metric learning, etc.), unsupervised learning, (e.g., association rule learning, clustering, etc.), reinforcement learning, semi-supervised learning, self-supervised learning, multi-instance learning, inductive learning, deductive inference, transductive learning, sparse dictionary learning and the like. Example clustering algorithms used in unsupervised learning may include, for example, k-means clustering, density based special clustering of applications with noise (e.g., DBSCAN), mean shift clustering, expectation maximization (e.g., EM) clustering using Gaussian mixture models (e.g., GMM), agglomerative hierarchical clustering, or the like. In one embodiment, clustering of data may be performed using a cluster model to group data points based on certain similarities using unlabeled data. Example cluster models may include, for example, connectivity models, centroid models, distribution models, density models, group models, graph based models, neural models and the like.

One subfield of machine learning includes neural networks, which take inspiration from biological neural networks. In machine learning, a neural network includes interconnected units that process information by responding to external inputs to find connections and derive meaning from undefined data. A neural network can, in a sense, learn to perform tasks by interpreting numerical patterns that take the shape of vectors and by categorizing data based on similarities, without being programmed with any task-specific rules. A neural network generally includes connected units, neurons, or nodes (e.g., connected by synapses) and may allow for the machine learning program to improve performance. A neural network may define a network of functions, which have a graphical relationship. Various neural networks that implement machine learning exist including, for example, feedforward artificial neural networks, perceptron and multilayer perceptron neural networks, radial basis function artificial neural networks, recurrent artificial neural networks, modular neural networks, long short term memory networks, as well as various other neural networks.

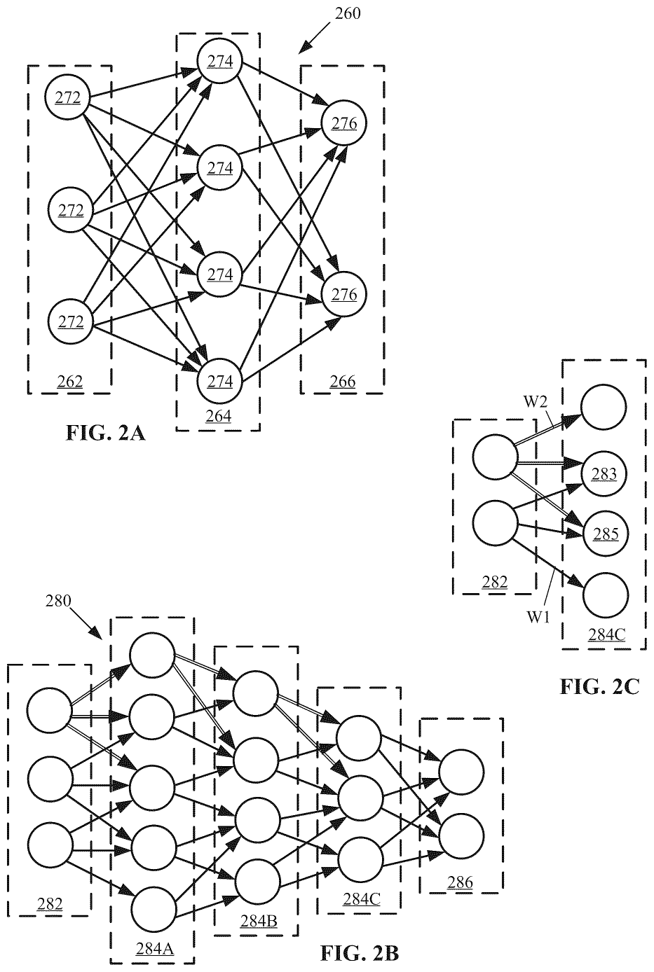

A feedforward network 260 (as depicted in FIG. 2A) may include a topography with a hidden layer 264 between an input layer 262 and an output layer 266. The input layer 262 includes input nodes 272 that communicate input data, variables, matrices, or the like to the hidden layer 264 that is implemented with hidden layer nodes 274. The hidden layer 264 generates a representation and/or transformation of the input data into a form that is suitable for generating output data. Adjacent layers of the topography are connected at the edges of the nodes of the respective layers, but nodes within a layer typically are not separated by an edge.

In at least one embodiment of such a feedforward network, data is communicated to the nodes 272 of the input layer, which then communicates the data to the hidden layer 264. The hidden layer 264 may be configured to determine the state of the nodes in the respective layers and assign weight coefficients or parameters of the nodes based on the edges separating each of the layers. That is, the hidden layer 264 implements activation functions between the input data communicated from the input layer 262 and the output data communicated to the nodes 276 of the output layer 266.

It should be appreciated that the form of the output from the neural network may generally depend on the type of model represented by the algorithm. Although the feedforward network 260 of FIG. 2A expressly includes a single hidden layer 264, other embodiments of feedforward networks within the scope of the descriptions can include any number of hidden layers. The hidden layers are intermediate the input and output layers and are generally where all or most of the computation is done.

Neural networks may perform a supervised learning process where known inputs and known outputs are utilized to categorize, classify, or predict a quality of a future input. However, additional or alternative embodiments of the machine learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem.

Generally, the machine learning algorithm may adjust the weight coefficients until any error in the output data generated by the algorithm is less than a predetermined, acceptable level. For instance, the training process may include comparing the generated output produced by the network in response to the training data with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between −1 and 1) may be used to modify the previous coefficient (e.g., a propagated value). The machine learning algorithm may be considered sufficiently trained when the associated error amount for the output data is less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

An additional or alternative type of neural network suitable for use in the machine learning program and/or module is a Convolutional Neural Network (“CNN”). A CNN is a type of feedforward neural network that may be utilized to model data associated with input data having a grid-like topology. In some embodiments, at least one layer of a CNN may include a sparsely connected layer, in which each output of a first hidden layer does not interact with each input of the next hidden layer. For example, the output of the convolution in the first hidden layer may be an input of the next hidden layer, rather than a respective state of each node of the first layer. CNNs are typically trained for pattern recognition, such as speech processing, language processing, and visual processing. As such, CNNs may be particularly useful for implementing optical and pattern recognition programs required from the machine learning program.

A CNN includes an input layer, a hidden layer, and an output layer, typical of feedforward networks, but the nodes of a CNN input layer are generally organized into a set of categories via feature detectors and based on the receptive fields of the sensor, retina, input layer, etc. Each filter may then output data from its respective nodes to corresponding nodes of a subsequent layer of the network. A CNN may be configured to apply the convolution mathematical operation to the respective nodes of each filter and communicate the same to the corresponding node of the next subsequent layer. As an example, the input to the convolution layer may be a multidimensional array of data. The convolution layer, or hidden layer, may be a multidimensional array of parameters determined while training the model.

An example convolutional neural network CNN is depicted and referenced as 280 in FIG. 2B. As in the basic feedforward network 260 of FIG. 2A, the illustrated example of FIG. 2B has an input layer 282 and an output layer 286. However where a single hidden layer 264 is represented in FIG. 2A, multiple consecutive hidden layers 284A, 284B, and 284C are represented in FIG. 2B. The edge neurons represented by white-filled arrows highlight that hidden layer nodes can be connected locally, such that not all nodes of succeeding layers are connected by neurons. FIG. 2C, representing a portion of the convolutional neural network 280 of FIG. 2B, specifically portions of the input layer 282 and the first hidden layer 284A, illustrates that connections can be weighted. In the illustrated example, labels W1 and W2 refer to respective assigned weights for the referenced connections. Two hidden nodes 283 and 285 share the same set of weights W1 and W2 when connecting to two local patches.

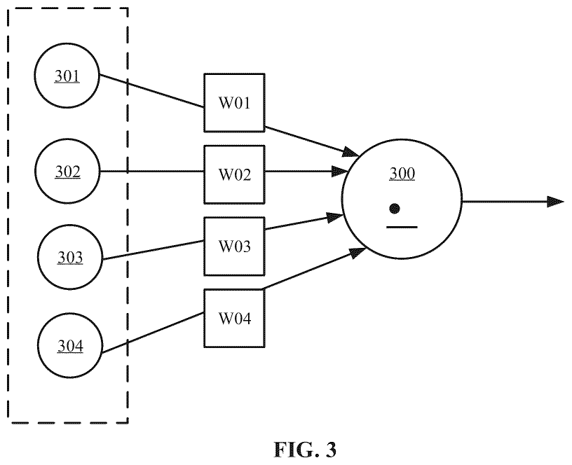

Weight defines the impact a node in any given layer has on computations by a connected node in the next layer. FIG. 3 represents a particular node 300 in a hidden layer. The node 300 is connected to several nodes in the previous layer representing inputs to the node 300. The input nodes 301, 302, 303 and 304 are each assigned a respective weight W01, W02, W03, and W04 in the computation at the node 300, which in this example is a weighted sum.

An additional type of feedforward neural network suitable for use in the machine learning program and/or module is a Recurrent Neural Network (“RNN”). An RNN may allow for analysis of sequences of inputs rather than only considering the current input data set. RNNs typically include feedback loops/connections between layers of the topography, thus allowing parameter data to be communicated between different parts of the neural network. RNNs typically have an architecture including cycles, where past values of a parameter influence the current calculation of the parameter. That is, at least a portion of the output data from the RNN may be used as feedback or input in calculating subsequent output data. In some embodiments, the machine learning module may include an RNN configured for language processing (e.g., an RNN configured to perform statistical language modeling to predict the next word in a string based on the previous words). The RNN(s) of the machine learning program may include a feedback system suitable to provide the connection(s) between subsequent and previous layers of the network.

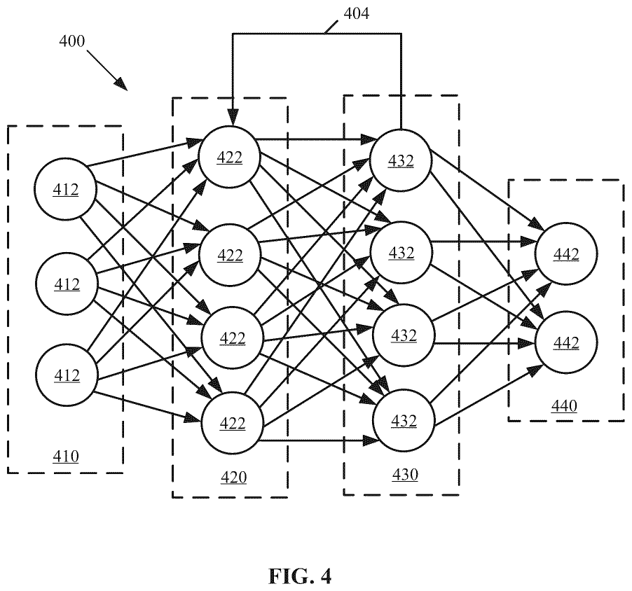

An example RNN is referenced as 400 in FIG. 4. As in the basic feedforward network 260 of FIG. 2A, the illustrated example of FIG. 4 has an input layer 410 (with nodes 412) and an output layer 440 (with nodes 442). However, where a single hidden layer 264 is represented in FIG. 2A, multiple consecutive hidden layers 420 and 430 are represented in FIG. 4 (with nodes 422 and nodes 432, respectively). As shown, the RNN 400 includes a feedback connector 404 configured to communicate parameter data from at least one node 432 from the second hidden layer 430 to at least one node 422 of the first hidden layer 420. It should be appreciated that two or more nodes of a subsequent layer may provide or communicate a parameter or other data to a previous layer of the RNN network 400. Moreover, in some embodiments, the RNN 400 may include multiple feedback connectors 404 (e.g., connectors 404 suitable to communicatively couple pairs of nodes and/or connector systems 404 configured to provide communication between three or more nodes). Additionally or alternatively, the feedback connector 404 may communicatively couple two or more nodes having at least one hidden layer between them (i.e., nodes of nonsequential layers of the RNN 400).

In an additional or alternative embodiment, the machine learning program may include one or more support vector machines. A support vector machine may be configured to determine a category to which input data belongs. For example, the machine learning program may be configured to define a margin using a combination of two or more of the input variables and/or data points as support vectors to maximize the determined margin. Such a margin may generally correspond to a distance between the closest vectors that are classified differently. The machine learning program may be configured to utilize a plurality of support vector machines to perform a single classification. For example, the machine learning program may determine the category to which input data belongs using a first support vector determined from first and second data points/variables, and the machine learning program may independently categorize the input data using a second support vector determined from third and fourth data points/variables. The support vector machine(s) may be trained similarly to the training of neural networks (e.g., by providing a known input vector, including values for the input variables) and a known output classification. The support vector machine is trained by selecting the support vectors and/or a portion of the input vectors that maximize the determined margin.

As depicted, and in some embodiments, the machine learning program may include a neural network topography having more than one hidden layer. In such embodiments, one or more of the hidden layers may have a different number of nodes and/or the connections defined between layers. In some embodiments, each hidden layer may be configured to perform a different function. As an example, a first layer of the neural network may be configured to reduce a dimensionality of the input data, and a second layer of the neural network may be configured to perform statistical programs on the data communicated from the first layer. In various embodiments, each node of the previous layer of the network may be connected to an associated node of the subsequent layer (dense layers).

Generally, the neural network(s) of the machine learning program may include a relatively large number of layers (e.g., three or more layers) and are referred to as deep neural networks. For example, the node of each hidden layer of a neural network may be associated with an activation function utilized by the machine learning program to generate an output received by a corresponding node in the subsequent layer. The last hidden layer of the neural network communicates a data set (e.g., the result of data processed within the respective layer) to the output layer. Deep neural networks may require more computational time and power to train, but the additional hidden layers provide multistep pattern recognition capability and/or reduced output error relative to simple or shallow machine learning architectures (e.g., including only one or two hidden layers).

According to various implementations, deep neural networks incorporate neurons, synapses, weights, biases, and functions and can be trained to model complex non-linear relationships. Various deep learning frameworks may include, for example, TensorFlow, MxNet, PyTorch, Keras, Gluon, and the like. Training a deep neural network may include complex input output transformations and may include, according to various embodiments, a backpropagation algorithm. According to various embodiments, deep neural networks may be configured to classify images of handwritten digits from a dataset or various other images. According to various embodiments, the datasets may include a collection of files that are unstructured and lack predefined data model schema or organization. Unlike structured data, which is usually stored in a relational database (RDBMS) and can be mapped into designated fields, unstructured data comes in many formats that can be challenging to process and analyze. Examples of unstructured data may include, according to non-limiting examples, dates, numbers, facts, emails, text files, scientific data, satellite imagery, media files, social media data, text messages, mobile communication data, and the like.

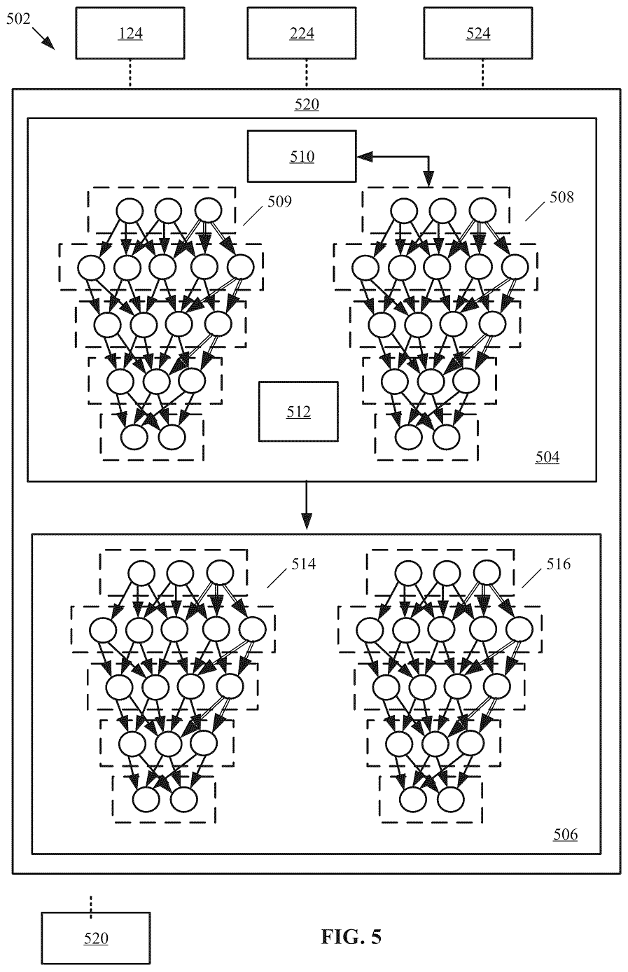

Referring now to FIG. 5 and some embodiments, an artificial intelligence program 502 may include a front-end algorithm 504 and a back-end algorithm 506. The artificial intelligence program 502 may be implemented on an AI processor 520. The instructions associated with the front-end algorithm 504 and the back-end algorithm 506 may be stored in an associated memory device and/or storage device of the system (e.g., storage device 124, memory device 122, storage device 124, and/or memory device 222) communicatively coupled to the AI processor 520, as shown. Additionally or alternatively, the system may include one or more memory devices and/or storage devices (represented by memory 524 in FIG. 5) for processing use and/or including one or more instructions necessary for operation of the AI program 502. In some embodiments, the AI program 502 may include a deep neural network (e.g., a front-end network 504 configured to perform pre-processing, such as feature recognition, and a back-end algorithm 506 configured to perform an operation on the data set communicated directly or indirectly to the back-end algorithm 506). For instance, the front-end algorithm 504 can include at least one CNN 508 communicatively coupled to send output data to the back-end algorithm 506.

Additionally or alternatively, the front-end algorithm 504 can include one or more AI algorithms 510, 512 (e.g., statistical models or machine learning programs such as decision tree learning, associate rule learning, recurrent artificial neural networks, support vector machines, and the like). In various embodiments, the front-end algorithm 504 may be configured to include built in training and inference logic or suitable software to train the neural network prior to use (e.g., machine learning logic including, but not limited to, image recognition, mapping and localization, autonomous navigation, speech synthesis, document imaging, or language translation, such as natural language processing). For example, a CNN 508 and/or AI algorithm 510 may be used for image recognition, input categorization, and/or support vector training.

In some embodiments and within the front-end algorithm 504, an output from an AI algorithm 510 may be communicated to a CNN 508 or 509, which processes the data before communicating an output from the CNN 508, 509 and/or the front-end algorithm 504 to the back-end program 506. In various embodiments, the back-end network 506 may be configured to implement input and/or model classification, speech recognition, translation, and the like. For instance, the back-end network 506 may include one or more CNNs (e. g,, CNN 514) or dense networks (e.g., dense networks 516), as described herein.

For instance and in some embodiments of the AI program 502, the program may be configured to perform unsupervised learning, in which the machine learning program performs the training process using unlabeled data (e.g., without known output data with which to compare). During such unsupervised learning, the neural network may be configured to generate groupings of the input data and/or determine how individual input data points are related to the complete input data set (e.g., via the front-end algorithm 504). For example, unsupervised training may be used to configure a neural network to generate a self-organizing map, reduce the dimensionally of the input data set, and/or to perform outlier/anomaly determinations to identify data points in the data set that falls outside the normal pattern of the data. In some embodiments, the AI program 502 may be trained using a semi-supervised learning process in which some but not all of the output data is known (e.g., a mix of labeled and unlabeled data having the same distribution).

In some embodiments, the AI program 502 may be accelerated via AI processor 520 (e.g., hardware). The machine learning framework may include an index of basic operations, subroutines, and the like (primitives) typically implemented by AI and/or machine learning algorithms. Thus, the AI program 502 may be configured to utilize the primitives of the AI processor 520 to perform some or all of the calculations required by the AI program 502. Primitives suitable for inclusion in the AI processor 520 include operations associated with training a convolutional neural network (e.g., pools), tensor convolutions, activation functions, basic algebraic subroutines and programs (e.g., matrix operations, vector operations), numerical method subroutines and programs, and the like.

It should be appreciated that the machine learning program may include variations, adaptations, and alternatives suitable to perform the operations necessary for the system, and the present disclosure is equally applicable to such suitably configured machine learning and/or artificial intelligence programs, modules, etc. For instance, the machine learning program may include one or more long short-term memory (“LSTM”) RNNs, convolutional deep belief networks, deep belief networks DBNs, and the like. DBNs, for instance, may be utilized to pre-train the weighted characteristics and/or parameters using an unsupervised learning process. Further, the machine learning module may include one or more other machine learning tools (e.g., Logistic Regression (“LR”), Naive-Bayes, Random Forest (“RF”), matrix factorization, and support vector machines) in addition to, or as an alternative to, one or more neural networks, as described herein.

Those of skill in the art will also appreciate that other types of neural networks may be used to implement the systems and methods disclosed herein, including, without limitation, radial basis networks, deep feed forward networks, gated recurrent unit networks, auto encoder networks, variational auto encoder networks, Markov chain networks, Hopefield Networks, Boltzman machine networks, deep belief networks, deep convolutional networks, deconvolutional networks, deep convolutional inverse graphics networks, generative adversarial networks, liquid state machines, extreme learning machines, echo state networks, deep residual networks, Kohonen networks, and neural turning machine networks, as well as other types of neural networks known to those of skill in the art.

To implement natural language processing technology, suitable neural network architectures can include, without limitation: (i) multilayer perceptron (“MLP”) networks having three or more layers and that utilizes a nonlinear activation function (mainly hyperbolic tangent or logistic function) that allows the network to classify data that is not linearly separable; (ii) convolutional neural networks; (iii) recursive neural networks; (iv) recurrent neural networks; (v) Long Short-Term Memory (“LSTM”) network architecture; (vi) Bidirectional Long Short-Term Memory network architecture, which is an improvement upon LSTM by analyzing word, or communication element, sequences in forward and backward directions; (vii) Sequence-to-Sequence networks; and (viii) shallow neural networks such as word2vec (i.e., a group of shallow two-layer models used for producing word embedding that takes a large corpus of alphanumeric content data as input to produces a vector space where every word or communication element in the content data corpus obtains the corresponding vector in the space).

With respect to clustering software processing techniques that implement unsupervised learning, suitable neural network architectures can include, but are not limited to: (i) Hopefield Networks; (ii) a Boltzmann Machines; (iii) a Sigmoid Belief Net; (iv) Deep Belief Networks; (v) a Helmholtz Machine; (vi) a Kohonen Network where each neuron of an output layer holds a vector with a dimensionality equal to the number of neurons in the input layer, and in turn, the number of neurons in the input layer is equal to the dimensionality of data points given to the network; (vii) a Self-Organizing Map (“SOM”) having a set of neurons connected to form a topological grid (usually rectangular) that, when presented with a pattern, the neuron with closest weight vector is considered to be the output with the neuron's weight adapted to the pattern, as well as the weights of neighboring neurons, to naturally find data clusters; and (viii) a Centroid Neural Network that is premised on Kmeans clustering software processing techniques.

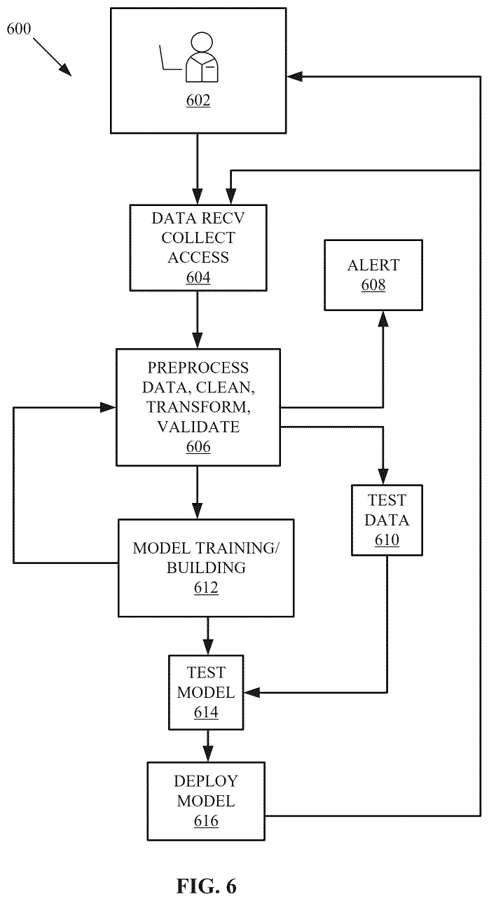

Turning to FIG. 6, a flow chart representing a method 600, according to at least one embodiment, of model development and deployment by machine learning. The method 600 represents at least one example of a machine learning workflow in which steps are implemented in a machine learning project.

In step 602, a user authorizes, requests, manages, or initiates the machine-learning workflow. This may represent a user such as human agent, or customer, requesting machine-learning assistance or AI functionality to simulate intelligent behavior (such as a virtual agent) or other machine-assisted or computerized tasks that may, for example, entail visual perception, speech recognition, decision-making, translation, forecasting, predictive modelling, and/or suggestions as non-limiting examples. In a first iteration from the user perspective, step 602 can represent a starting point. However, with regard to continuing or improving an ongoing machine learning workflow, step 602 can represent an opportunity for further user input or oversight via a feedback loop. Such feedback may flow through a user, or in various embodiments, the method automatically provides feedback, retrains and redeploys the retrained model.

In step 604, user evaluation data is received, collected, accessed, or otherwise acquired and entered as can be termed data ingestion. In step 606 the data ingested in step 604 is pre-processed, for example, by cleaning, and/or transformation such as into a format that the following components can digest. The incoming data may be versioned to connect a data snapshot with the particularly resulting trained model. As newly trained models are tied to a set of versioned data, preprocessing steps are tied to the developed model. If new data is subsequently collected and entered, a new model will be generated. If the preprocessing step 606 is updated with newly ingested data, an updated model will be generated.

Step 606 can include data validation to confirm that the statistics of the ingested data are as expected, such as that data values are within expected numerical ranges, that data sets are within any expected or required categories, and that data comply with any needed distributions such as within those categories. Step 606 can proceed to step 608 to automatically alert the initiating user, other human or virtual agents, and/or other systems, if any anomalies are detected in the data, thereby pausing or terminating the process flow until corrective action is taken.

In step 610, training test data such as a target variable value is inserted into an iterative training and testing loop. In step 612, model training, a core step of the machine learning work flow, is implemented. A model architecture is trained in the iterative training and testing loop. For example, features in the training test data are used to train the model based on weights and iterative calculations in which the target variable may be incorrectly predicted in an early iteration as determined by comparison in step 614, where the model is tested. Subsequent iterations of the model training, in step 612, may be conducted with updated weights in the calculations.

During each iteration of the training and testing loop, the accuracy of the model may be evaluated. In one embodiment, the re-evaluation of the model can include comparing an output of the model with an actual target result or variable to determine the accuracy of the prediction. If the model is not satisfying a minimum threshold level of accuracy (i.e., the model is underfitted), the system may automatically determine that the threshold level of accuracy is not satisfied and may adjust the weights for a subsequent iteration of the training and testing loop.

The weights may be iteratively adjusted during each iteration of the training and testing loop based on the comparison to the threshold level of accuracy. However, there is a balance for training the model in order to avoid overfitting when the model would not perform well on predictions of new data. Rather, the model is automatically trained to be well-fitted such that it satisfies a threshold level of accuracy without learning the noise in the data to the extent that the model would not apply to new data by preventing additional iterations of the training and testing once a maximum accuracy threshold value has been obtained. Thus, with each iteration of the training and testing loop, the accuracy of the model is improved and the iterative training and testing of the model provides an improvement to the performance of a computer and computing technology because the system may automatically determine how many iterations to perform so that the model is well-fitted by surpassing the minimum threshold level of accuracy while automatically stopping the iterative training and testing of the model before the maximum accuracy threshold is obtained.

In some embodiments, the training and testing loop utilizes a backpropagation algorithm and a gradient descent algorithm. Gradient descent is an optimization algorithm used to minimize differentiable real-valued multivariate functions. Gradient descent is an optimization algorithm used to minimize differentiable real-valued multivariate functions. The gradient descent algorithm may be used to iteratively adjust model parameters using calculated derivatives to minimize a loss function. Backpropagation may be used to calculate the gradient of the error function with respect to the neural network's weights.

When compliance and/or success in the model testing in step 614 is achieved, process flow proceeds to step 616, where model deployment is triggered. The model may be utilized in AI functions and programming, for example to simulate intelligent behavior, to perform machine-assisted or computerized tasks, of which visual perception, speech recognition, decision-making, translation, forecasting, predictive modelling, and/or automated suggestion generation serve as non-limiting examples.

As discussed above, oversight of a deployed machine learning model may be automatically performed via a feedback loop whereby the method assesses performance of the deployed model (see step 616) and the feedback loop automatically provides feedback for further training of the machine learning model to improve its performance, and upon completion of the other method steps such as 612, the machine learning model that has been automatically retrained based on the feedback loop is then redeployed (step 614). In some embodiments, the system is continually receiving training data as new predictions are made and more data is collected. The continuous training data may be discretized to generate input data to retrain the model. Discretization methods can convert continuous data to discrete data by binning, clustering, and numerical discretization. The model may monitor incoming data sets to make predictions. When predictions are made the system analyzes the predictions to determine whether the model needs to be retrained.

In some embodiments, the model may detect anomalies in the predictions. Anomaly detection can provide a benefit by identifying instances of the prediction that deviate from expected data or a general pattern. A difficulty in anomaly detection is that the system must define the boundary between ordinary data and anomalous data to accurately classify the data as ordinary or anomalous. The line between ordinary and anomalous may be difficult to determine with cases approaching a boundary and based on the specific application. For example, small variations may trigger an identification of an anomaly in the data while relatively larger deviations may be considered normal in less sensitive applications. The disclosed systems and methods may provide solutions to detecting anomalies in order to more accurately and quickly determine whether a model needs to be retrained. If data would be inapplicable or would corrupt the model by reducing the quality of the input data or training process (e.g., due to missing values, outliers, inconsistent formatting, incorrect labels, noisy data, etc.) that data may be automatically dropped and the source of that data may be blocked from providing data that would be used to train the model. This reflects an improvement in the process of training and deploying a model that is accurate and specific to the type of prediction sought. In particular, this provides an improvement in the field of model training, which provides a practical application.

In other applications, the anomaly detections processes described herein may be used to provide enhanced security to the overall computing system by detecting malicious attacks on network security. For example, the system may take proactive measures to remediate danger by detecting the source address associated with potentially malicious packets and dropping potentially malicious packets. This provides an improvement in network security by dropping potentially malicious packets and blocking future traffic from the source address of the potentially malicious source address.

### Automated Failure Management Overview

A system failure or fault refers to a circumstance where a computer system or network is unable to perform one or more intended functions or experiences a significant disruption in operation. System faults can negatively impact functions utilized by customer end users resulting in customer friction, delays, and a loss of trust. For end users that are internal to the enterprise (e.g., agents and employees), system faults impair the ability of end users to perform his or her job function resulting in substantial costs because of a loss in productivity as well as costs incurred investigating and deploying a correction or fix for the fault. When systems fail, end users might be unable to access critical services, lose unsaved work, or experience disruptions in workflow.

System faults can occur as a result of varying reasons, such as hardware malfunctions, mistakes or logical flaws in the software source code, missing or incorrect data, loss of power, insufficient network resources, inadequate maintenance, human errors, cyberattacks, and security breaches, among many other causes. The faults also give rise to a range of negative effects, including slow response times, error messages, warnings, crashes (i.e., when a computing device restarts, shuts down, or freezes and stops responding to user inputs or displaying new outputs), data corruption where data or files are lost or corrupted (i.e., improperly modified such that the data is unusable) if the data is being written or accessed at the time of a fault, unusual system behavior, or the inability to access certain functions or services.

Existing techniques for managing fault are reactionary and address faults after they arise. Provider end users must devote time to investigating the cause of a fault, characterizing the fault, and developing or selecting a correction to remove the fault. The corrective measures taken often do not address the root cause of a fault and are not effective at preventing future faults of the same or a similar nature. The systems and methods disclosed in this application enable the automatic detection and characterization of faults as well as the automated development or selection of corrective measures.

System faults can be manually observed by end users or automatically reported using error codes and electronic notifications. Faults are characterized according to a wide variety of criteria such as the software application impacted and number of users impacted. Data relating to the faults is stored by the system for further analysis. The analysis of system faults allows a provider to recognize trends in the type or frequency of faults and facilitate development or selection of a correction for the fault.

The present system records and characterizes the system faults so that providers can identify faults that occur most often, that are most severe with respect to degradation of system operation, and that impact the most end users. This in turn allows providers to prioritize particular faults and focus efforts on deploying corrections to faults having the highest priority. In this manner, a provider can take proactive steps to prevent system faults rather than continuing to address system faults using traditional reactive techniques. As discussed in more detail below, the system also automatically corrects faults where possible. Resolving the fault can include selecting from a set of known solutions that correlate to a particular system fault or generating a new solution that corrects the system fault.

The proactive, automated features of the current system gives rise to advantages over existing fault detection and correction systems. The advantages of the present system include: (i) reduced system downtime that would otherwise negatively impact productivity and drive up costs; (ii) improved system reliability and stability (i.e., longer periods of consistent operation without reductions in functionality); (iii) optimization of system resource utilization, such as reduced costs and reduced personnel requirements; (iv) enhanced end user experience through minimizing disruptions and reductions in system functionality; (v) the ability to scale, if needed, to address increased volumes of system faults that would otherwise require dedicating more provider personnel to detection and correction; and (vi) continuous improvement and optimization by using machine learning technology to improve the efficacy of corrections as the system is trained on system faults.

### Detection, Characterization, and Correction of Faults

The system characterizes and records faults observed and reported by end users or that are automatically detected through system monitoring software services. Reported and detected faults include one or more categories of fault reporting data, including, without limitation: (i) an end user identification (e.g., a username, user identification number, or account number); (ii) device identification data (e.g., an Internet Protocol (“IP”) address, a Media Access Control (“MAC”) address, or a unique device identification number); (iii) a network identification (e.g., an Internet service provider or an identifiable subgroup or location within a provider network; (iv) location data (e.g., a city and state where the end user who experienced the fault is located); (v) application identification data (e.g., the name of the software application that exhibited the fault or that an end user was using at the time of the fault); (vi) a hardware identification (e.g., an identification for a hardware component that failed); (vii) content data (e.g., a narrative description of the fault); (viii) image data (e.g., a screen capture or other image that describes the fault or the effects of the fault); (ix) a universal resource locator (“URL”) (e.g., a website address associated with a fault that relates to a website); (x) an error code (e.g., an assigned alphanumeric value that correlates to a particular type of fault); (xi) a log file (e.g., a record of operations performed by a computing device or software application, including data received, processed, and transmitted); and (xii) in some cases, the actual source.

End users report system faults through a variety of channels, such as telephone calls to provider personnel, submission through a website or mobile software application, by email, or through an instant “chat” messaging software application. End users are prompted to enter one or more categories of fault reporting data, or the electronic submission form (e.g., a website or mobile application) includes labeled data fields corresponding to categories of fault reporting data that end users must input to report the fault.

The system also automatically detects system faults through a variety of channels, such as generating and transmitting fault notifications and the use of network or system monitoring platforms. With system fault notifications, the computing devices and software applications operating within a network are configured to generate fault notifications upon the occurrence of an error or failure. The fault notification are transmitted to a failure management software application that records and process fault notifications, such as a “FailSafe Pro” software application. The fault notifications include fault reporting data and are stored to a fault tracking database. The system optionally displays the fault notification or an alert summarizing the notification on the display screen of a provider end user computing device.

Network or system monitoring platforms facilitate detection of system faults by monitoring specified performance indicators, such as a processor utilization percentage, transient memory utilization (e.g., a proportion of random access memory capacity that is being utilized), network traffic utilization (e.g., a percentage of network capacity being used), network latency, or storage device activity (e.g., hard drive utilization). When a performance indicator exceeds a specified minimum or maximum threshold, the system records the threshold violation event as a system fault. The network monitoring platform records available fault reporting data, such as a network identification, a log file, or an identification for the software component or the hardware component that exhibited the fault. The threshold violation and associated fault reporting data is transmitted to the failure management software application for recording and processing.

The system characterizes faults so that a provider can determine the types faults that are occurring, identify the systems and software applications that are most prone to faults, and evaluate the severity of the faults, among other information. Characterizing the faults permits a provider to evaluate trends in the occurrence of system faults, such as determining the frequency of occurrence for certain faults, identifying software applications or components that exhibit the most faults or the highest proportion of faults, or determining whether the frequency of certain faults is increasing or decreasing. This allows providers to prioritize the types of faults to correct.

The system characterizes or classifies faults according to one or more criteria, such as: (i) the software application or component that exhibited the fault; (ii) the hardware component or computing device that exhibited the fault; (iii) a description of the fault behavior or result (i.e., what happened as a result of the fault-a computing device crash, deletion of data input by an end user, failure of a user interface to display, etc.); (iv) the cause of the fault (e.g., memory buffer overflow, the entry of data that was out of range, etc.); or (v) the type of software application that exhibited the fault, such as operating systems (e.g., Microsoft® Windows®, macOS®, and Linux®), system software (e.g., device drivers, firmware, system utilities, and security software), and application software (e.g., word processing software or spreadsheet software). The results of the fault characterization are stored as characterization data in a fault tracking database and associated with a particular fault or category of faults.

Characterization of the fault can include applying a label to the fault that describes the fault type or fault severity. The fault can be labeled according to a fault type or category, such as: (i) a “login fault” that occurred while an end user is attempting to log into a provider system; (ii) a “data error” fault that results from expected data being out of range or non-existent; (iii) a “network fault” that occurs as a result of the loss of communication connectivity or the delayed receipt of data over a network; or (iv) a “mobile application fault” that occurs when an end user is unable to perform certain operation on a mobile software application, such as institute an electronic transfer. A fault can be labeled according to severity, such as a “critical application fault” indicating that the fault relates to a software application that is critical to the provider's business. Skilled artisans will appreciate these are just a few of the many types of faults that could occur.

The system characterizes faults using the fault reporting data. The faults can be characterized manually using data input by end users who reported the fault. The faults can also be characterized automatically using fault reporting data generated by the computing device that reported the fault, such when the computing device automatically reports a software application that exhibited the fault or reports the probable cause of the fault based on information recorded to a log file. The faulting reporting data is included in a fault notification message.

In some embodiments, machine learning technology is utilized to characterize the fault. Machine learning techniques can include trained neural networks that accepts systems and software configuration data, fault reporting data, or historical fault reporting data, among other types. The system runs a characterization analysis in which faults are classified using neural networking technology to determine the probability that a fault fits within a particular label or classification. The system can be configured to label the fault according to the label having the highest probability of describing the fault.

To illustrate with a simplified example, the fault reporting data might show that the end user computing device was accessing the provider system using a mobile software application, the end user was attempting to download content having a large file size, and that a log file reported slow network performance prior to the fault using a cellular data connection. They neural network analysis could determine in that scenario that the fault is most likely characterized as a “network connectivity” type of fault given that prior faults with those attributes were similarly characterized. Or if a computing device reports that the provider login website was accessed multiple times in a short duration prior to the fault, the neural network could conclude that fault was a “login fault” based on historical data showing those factors are common prior to a login error.

Once a fault is detected and characterized, the system can be configured to correct the fault manually or automatically. In embodiments where faults are at least in part corrected manually, the system can perform a routing analysis to determine the most qualified provider agent to correct the fault based on agent experience, education, training, or other factors. In one embodiment, the routing analysis is conducted by a support vector machine utilizing logistic regression to make a binary prediction that determines whether a provider agent is a match. The routing analysis can also utilize other regression models to match a correction to provider personnel. If a match is made between a fault and a provider agent agent, then a notification is sent to the agent of the fault, and the fault is assigned to the agent for investigation and correction.

In other embodiments, the system automatically generates corrections for the faults using one of a plurality of techniques. The system includes a fault correction database that stores data concerning specific faults or categories of faults that are associated with known correction solutions that mitigate or eliminate the faults.

Example corrections can include, without limitation: (i) software code that implements a patch that eliminates or mitigates a fault; (ii) deactivating or updating a software application associated with the fault; (iii) isolating a particular data port, computing device, or software application; (iv) changes in software application settings or software service settings, such as not authorizing the transmission or receipt of particular file types, files, or data; (v) installing new software applications or services that detect, delete, prevent, or mitigate faults; (vi) using a template correction that consists of software source code known to enable particular operations when embedded in a larger program; or (vii) automatically deleting replacing, or adding software source code. The corrections are sent to a computing device that exhibited the fault along with computer readable software code that includes instructions for installing or implementing the correction.

The correction sent to a user computing device can be selected from the correction database that includes known corrections having known labels and other attributes based on the fault reporting data. The system characterizes a fault to determine a fault type and then determines from the correction database, the corrections associated with the same fault type. The corrections are sent to the computing device with instructions for installing the correction.

The corrections can be templates of source code known to address a specific type of fault. For example—(i) a null pointer exception can be corrected with insertion of a conditional statement to check whether the value of a variable is null; or (ii) or a memory leak can be corrected with automated insertion of missing memory deallocation statements. In addition to inserting template code, the automatic corrections can include deleting, replacing or adding sections of software code. When software code is replaced or added, the system can be configured to replicate source code from other portions of the same software application as the current software source code is more likely to be compatible and use the same defined variables, subroutine calls, among other similarities.

In some embodiments, the system utilizes machine learning technology implemented by a trained neural network to generate the correction. An analysis by the neural network uses the characterization and the fault reporting data to select or generate a correction that has the highest probability of fixing the fault. The neural network may also identify multiple corrections having the highest probabilities of fixing the fault where the corrections are presented to an individual end user for evaluation and selection of a correction. The correction is then deployed to a computing device that exhibited the error for installation of the correction.

The utilization of machine learning technology implemented by neural networks to make predictions about fault characterization and correction relies on the use of specially trained models to realize improvements over traditional methods of fault detection and correction, including more accurate and more complete characterization and tracking of faults. Further, the systems and methods disclosed herein lead to faster training times and significantly reduced fault corrections times as well as the ability to scale fault corrections through automation.

Although the foregoing description provides embodiments of the invention by way of example, it is envisioned that other embodiments may perform similar functions and/or achieve similar results. Any and all such equivalent embodiments and examples are within the scope of the present invention.

1. A system for fault management comprising a computer that includes a processor and a memory device storing data and executable code that, when executed, causes the processor to:
(a) instruct a computing device to report a fault notification, wherein
(i) the fault notification is generated in response to the occurrence of a fault caused by source software code that is an integrated part of a software application running on the computing device, and
(ii) the fault notification comprises fault reporting data relating to the fault;
(b) characterize the fault using the fault reporting data;
(c) apply a label to the fault based on the characterization, wherein the label comprises a fault type;
(d) generate a correction for the fault based on the fault characterization and the fault reporting data, wherein the correction comprises executable correction software code; and
(e) deploy the correction to the computing device for execution by the computing device.

2. The system for fault management of claim 1, wherein:
(a) the system comprises a correction database storing a plurality of known corrections that are each associated with at least one known label; and
(b) the executable code further causes the processor to
generate the correction by selecting a known correction that has a known label corresponding to the label applied to the fault.

3. The system for fault management of claim 1, wherein:
(a) the system comprises a correction database storing a plurality of known corrections that are each associated with at least one known operation;
(b) the fault is characterized according to an expected operation; and
(c) the executable code further causes the processor to generate the correction by selecting a known correction with a known operation that matches the expected operation.

4. The system for fault management of claim 1, wherein the correction comprises:
(a) a software update to the software application running on the computing device, and
(b) instructions for the software application to install the software update.

5. The system for fault management of claim 1, wherein:
(a) as part of the operation to generate a correction, the executable code further causes the processor to determine the source software code that caused the fault; and
(b) when executed by the computing device, the correction software code applies a modification to the source software code, wherein the modification is selected from one of (i) deleting part of the source software code, or (ii) inserting additional software code into the source software code.

6. The system for fault management of claim 51, wherein as part of the operation to generate a correction, the executable code further causes the processor to replace part of the source software code to generate replacement software code, wherein the replacement software code is generated using a software code portion that is an integrated part of the software application.

7. The system for fault management of claim 1, wherein as part of the operation to generate a correction, the executable code further causes the processor to:
(a) determine the source software code that caused the fault;
(b) identify a fix template comprising template software code;
(c) modify the template software code to incorporate a variable defined in the source software code; and
(d) insert the fix template into the source software code.

8. The system for fault management of claim 1, wherein as part of the operation to generate a correction, the executable code further causes the processor to:
determine source software code that caused the fault;
(b) select a software patch for the source software code; and
(c) incorporate the software patch within the correction along with executable instructions to install the software patch.

9. The system for fault management of claim 1, wherein:
(a) the system further comprises a neural network; and
(b) the neural network processes the source code and the fault reporting data to generate the correction software code.

10. The system for fault management of claim 1, wherein:
(a) the system comprises a correction database of known corrections;
(b) the system further comprises a neural network; and
(c) the neural network performs the operation to generate the correction by analyzing the fault reporting data to determine the known correction that has the highest probability of repairing the fault.

11. A system for fault management comprising a computer that comprises a database of known corrections, a neural network, a processor and a memory device storing data and executable code that, when executed, causes the processor to:
(a) record a plurality of faults, wherein each of the faults
(i) comprises fault reporting data, and
(ii) is generated in response to the occurrence of a failure caused by source software code integrated with a software application running on a computing device,
(b) characterize each of the faults using the fault reporting data;
(c) instruct the neural network to process the fault reporting data to identify at least one of the faults as a priority fault based on the characterization;
(d) instruct the neural network to process the known corrections and the fault reporting data to identify the known correction that has the highest probability of repairing the fault;
(e) process the known correction that has the highest probability of repairing to generate a selected correction for the priority fault, wherein the selected correction comprises executable correction software code; and
(f) deploy the correction to the computing device for execution.

12. The system for fault management of claim 11, wherein at the priority fault is selected according to a frequency of fault occurrence.

13. The system for fault management of claim 11, wherein at the priority fault is selected according to a fault severity.

14. The system for fault management of claim 11, wherein:
(a) the known corrections are each associated with at least one known operation;
the fault is characterized according to an expected operation; and
(c) the selected correction comprises a known operation that matches the expected operation.

15. The system for fault management of claim 11, wherein:
(a) the known corrections are each associated with at least one known label; and
(b) the executable code further causes the processor to
(i) apply a label to the fault based on the characterization, and
(ii) the selected correction comprises a known label corresponding to the label applied to the fault.

16. The system for fault management of claim 11, wherein:
(a) the neural network performs the operation to characterize the fault by analyzing the fault reporting data to determine a fault type.

17. The system for fault management of claim 1, wherein the correction software code, when executed, causes the computing device to perform operations selected from one of:
(a) deactivating the software application;
(b) installs a second software application that replaces the first software application; or
(c) changes one or more settings for the software application.

18. A system for fault management comprising a computer that includes a processor and a memory device storing data and executable code that, when executed, causes the processor to:
(a) capture monitoring data from a network monitoring system;
(b) compare the monitoring data against one or more fault thresholds;
(c) detect a fault when the monitoring data exceeds the fault threshold;
determine source code that cause the fault;
(d) capture fault reporting data relating to the fault;
(e) characterize the fault using the fault reporting data to identify a component that failed and a fault type, wherein the component is selected from one of a software application or hardware installed on the computing device;
(f) generate a correction that comprises executable correction software code that, when executed, modifies the source software code; and
(g) deploy the correction to the computing device for executing the instructions.

19. The system for fault management of claim 18, wherein:
(a) the system further comprises a neural network; and
(b) the neural network performs the operation to generate the correction by determining a known correction among the plurality of known corrections that has the highest probability of repairing the fault.

20. The system for fault management of claim 18, wherein the network monitoring data is a metric comprising one of a network traffic utilization or network latency.
